(19) United States
(12) Patent Application Publication
(10) Pub. No.: US 2023/0398796 A1
(43) Pub. Date: Dec. 14, 2023

(54) TRANSPORT ROLLER PAIR INCLUDING DRIVE ROLLER AND FOLLOWER ROLLER THAT TRANSPORT MEDIUM HELD THEREBETWEEN, MEDIUM TRANSPORT DEVICE, AND IMAGE FORMING APPARATUS

(71) Applicant: KYOCERA Document Solutions Inc., Osaka (JP)

(72) Inventor: Takatoshi NISHIMURA, Osaka (JP)

(73) Assignee: KYOCERA Document Solutions Inc., Osaka (JP)

(21) Appl. No.: 18/205,263

(22) Filed: Jun. 2, 2023

(30) Foreign Application Priority Data
Jun. 8, 2022 (JP) 2022-093186

(51) Int. Cl. B41J 13/03; B41J 13/076; B41J 13/02

(52) U.S. Cl. CPC B41J 13/03; B41J 13/076; B41J 13/025

(57) ABSTRACT

A transport roller pair includes a drive roller and a follower roller set. The drive roller is driven to rotate about a shaft. The follower roller set transports a medium held between the drive roller and the follower roller set, by being made to rotate about a shaft by the drive roller. The follower roller set includes at least one first roller and at least one second roller. The at least one first roller forms a first nip region by contacting the drive roller. The at least one second roller forms a second nip region by contacting the drive roller, at a position downstream of the first roller in a transport direction of the medium. The first roller is smaller in inertia than the second roller.

### INCORPORATION BY REFERENCE

This application claims priority to Japanese Patent Application No. 2022-093186 filed on Jun. 8, 2022, the entire contents of which are incorporated by reference herein.

### BACKGROUND

The present disclosure relates to a transport roller pair that transports a medium held therebetween, a medium transport device, and an image forming apparatus.

In general, an image forming apparatus includes a transport roller pair that transports a medium such as a sheet, held between a drive roller and a follower roller. In the case where the transport roller pair is employed to transport the medium, when the front end (leading edge) of the medium enters into the nip region between the transport roller pair, while the image forming operation is still being executed on the rear portion of the medium, the impact of collision with the roller is transmitted to the rear portion of the medium, which may incur a color shift in the image.

One of known techniques to alleviate such an impact (load) is bringing a plurality of following-side rollers of the same diameter, into contact with the driving-side roller. With such an arrangement, the position of the nip region (contact position) between the roller pair is shifted, with respect to the direction along the circumferential surface of the driving-side roller, and therefore the load imposed on the medium, when the leading edge thereof enters into the roller pair, is reduced.

### SUMMARY

The disclosure proposes further improvement of the foregoing techniques.

In an aspect, the disclosure provides a transport roller pair including a drive roller and a follower roller set. The drive roller is driven to rotate about a shaft. The follower roller set transports a medium held between the drive roller and the follower roller set, by being made to rotate about a shaft by the drive roller. The follower roller set includes at least one first roller and at least one second roller. The at least one first roller forms a first nip region by contacting the drive roller. The at least one second roller forms a second nip region by contacting the drive roller, at a position downstream of the first roller in a transport direction of the medium. The first roller is smaller in inertia than the second roller.

In another aspect, the disclosure provides a medium transport device including the transport roller pair, a pivotal shaft, a plurality of first pivotal arms, a plurality of second pivotal arms, and a plurality of biasing members. The pivotal shaft extends in a width direction. The first pivotal arms are each pivotably supported by the pivotal shaft, and rotatably support the first roller, on a side of a distal end extending from the pivotal shaft to one side in the transport direction. The plurality of second pivotal arms are each pivotably supported by the pivotal shaft, and rotatably support the second roller, on a side of a distal end extending from the pivotal shaft to one side in the transport direction. The biasing members respectively bias the first pivotal arms and the second pivotal arms, toward the drive roller.

In still another aspect, the disclosure provides an image forming apparatus including the foregoing transport roller pair, and an image forming device. The image forming device forms an image on the medium.

### BRIEF DESCRIPTION OF THE DRAWINGS

FIG. 1 is a front view schematically showing an internal configuration of an image forming apparatus according to a first embodiment;

FIG. 2 is a side view showing a medium transport device according to the first embodiment;

FIG. 3 is a cross-sectional view taken along a line III-III in FIG. 2;

FIG. 4 is a plan view showing the medium transport device according to the first embodiment;

FIG. 5 is a cross-sectional view showing a medium transport device according to a second embodiment;

FIG. 6 is a plan view showing a medium transport device according to a third embodiment; and

FIG. 7 is a cross-sectional view showing a medium transport device according to a fourth embodiment.

### DETAILED DESCRIPTION

Hereafter, some embodiments of the disclosure will be described, with reference to the accompanying drawings. The codes Fr, Rr, L, R, U, and D in the drawings stand for front, rear, left, right, upper, and lower sides, respectively. The terms herein used to indicate directions or positions are merely for the sake of convenience of description, and therefore not intended to limit the technical scope of the disclosure.

### [Image Forming Apparatus]

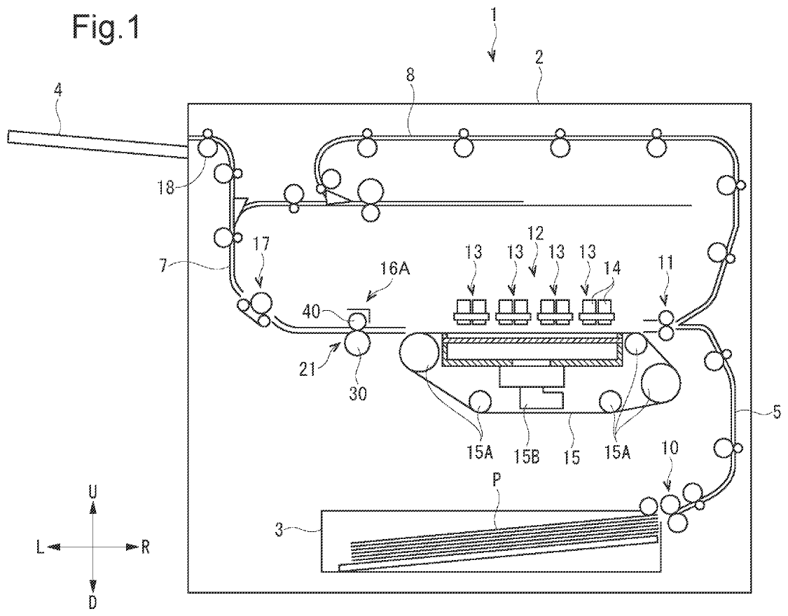

Referring to FIG. 1, an image forming apparatus 1 according to a first embodiment of the disclosure will be described. FIG. 1 is a front view schematically showing an internal configuration of the image forming apparatus 1.

The image forming apparatus 1 is an ink jet printer, configured to elect ink droplets onto a paper sheet P, thereby forming an image on the sheet P. The image forming apparatus 1 includes a box-shaped housing 2, in which various components are provided. A sheet cassette 3 for storing the sheets P is provided in the lower portion of the housing 2. At an upper position of the left side face of the housing 2, an output tray 4 is provided, to receive the sheet P that has undergone the printing operation. Hereinafter, the direction in which the sheet P, exemplifying the medium in the disclosure, is transported, will be referred to as “transport direction”. The terms “upstream”, “downstream” and the like represent the upstream side, downstream side, and the like, with respect to the transport direction. The medium is not limited to the paper sheet P, but may be, for example, a sheet made of a resin, or a film.

A first transport route 5, along which the sheet P is transported from the sheet cassette 3 to a head unit 12, is formed in the right-side region inside the housing 2. A sheet feeding device 10 is provided at the upstream end of the first transport route 5. At the downstream end of the first transport route 5, a resist roller 11 is provided.

The head unit 12 includes four line heads 13 respectively corresponding to four colors, namely black, cyan, magenta, and yellow. The line heads 13 each include a plurality of recording heads 14. To each of the recording heads 14, ink is supplied through a tube, from an ink pack of the corresponding color. A conveying belt 15, in which a multitude of through holes are formed, is provided on the lower side of the head unit 12. The conveying belt 15 is stretched over a plurality of engaging rollers 15A. On the inner side of the conveying belt 15, a suction device 15B is provided.

In the left-side region inside the housing 2, a second transport route 7, along which the sheet P is transported from the head unit 12 to the output tray 4, is provided. A medium transport device 16A is provided on the upstream side of the second transport route 7. A decurling device 17 is provided at a position halfway of the second transport route 7. At the downstream end of the second transport route 7, a delivery device 18 is provided. The medium transport device 16A includes a transport roller pair 21, configured to rotate about the shaft with the sheet P held therebetween, thus to transport the sheet P. In the upper region inside the housing 2, a third transport route 8, along which the sheet P is again transported to the resist roller 11 from a position halfway of the second transport route 7, is provided.

### [Image Forming Operation]

The image forming operation will be described hereunder. A controller of the image forming apparatus 1 controls various components as necessary, to thereby execute the image forming operation as specified below.

In the image forming operation, the sheet feeding device 10 feeds the sheet P picked up from the sheet cassette 3, to the first transport route 5. The resist roller 11 temporarily blocks the sheet P to correct a skew, and delivers the sheet P to the conveying belt 15, in accordance with the timing that ink droplets are ejected from the line heads 13. The sheet P is adsorbed to the conveying belt 15, while being conveyed. The recording heads 14 provided in the head unit 12 each eject the ink droplets (liquid droplets) onto the sheet P on the conveying belt 15, through a plurality of nozzles, thereby forming a full-color image. The transport roller pair 21 of the medium transport device 16A transports the sheet P on which the image has been formed, to the downstream side in the transport direction. The decurling device 17 serves to correct the curled form of the sheet P.

In the case of simplex printing, the sheet P having the image printed on one side thereof is delivered to the output tray 4, through the second transport route 7. In the case of duplex printing, the sheet P having the image printed on one side is guided to the third transport route 8, where the front and back faces are reversed, and again transported to the resist roller 11. On the back face of such sheet P, an image is formed in the same way as the simplex printing. The sheet P that has undergone the duplex printing process is delivered to the output tray 4.

Now, the transport roller pair 21 includes a drive roller 30 and a plurality of follower rollers 40, configured to rotate about the respective shafts with the sheet P held therebetween, to thereby transport the sheet P from the upstream side to the downstream side, in the transport direction. The leading edge (front end) of the sheet P delivered from the head unit 12 is abutted against (collides with) the contact portion (nip region) between the drive roller 30 and the follower rollers 40. Accordingly, the transport speed of the sheet P largely varies (decreases), and the impact or vibration arising from the collision is transmitted from the leading edge to the rear portion of the sheet P. In the case where the image forming operation is still being executed at this time point, on the rear portion of the sheet P, the rear portion of the sheet P may be slightly shifted backward by the impact, which may lead to occurrence of color shift on the image being formed. To avoid such a drawback, the transport roller pair 21 of the medium transport device 16A is configured to alleviate the impact applied to the sheet P entering into the nip region.

### [Medium Transport Device 16A]

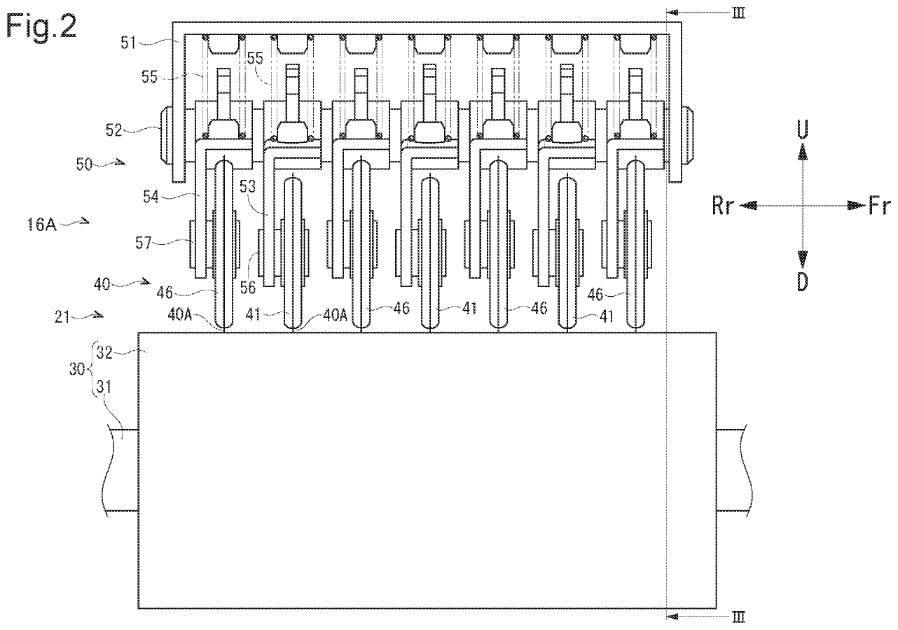

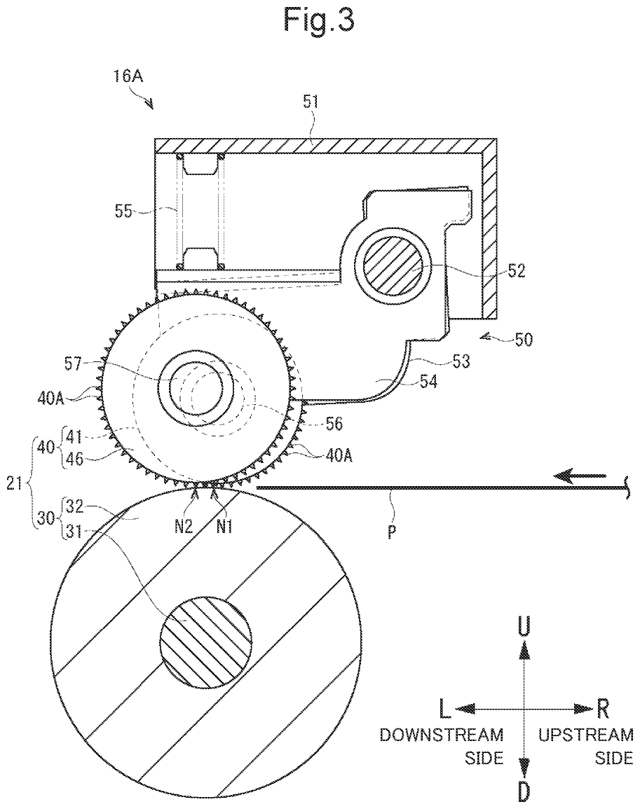

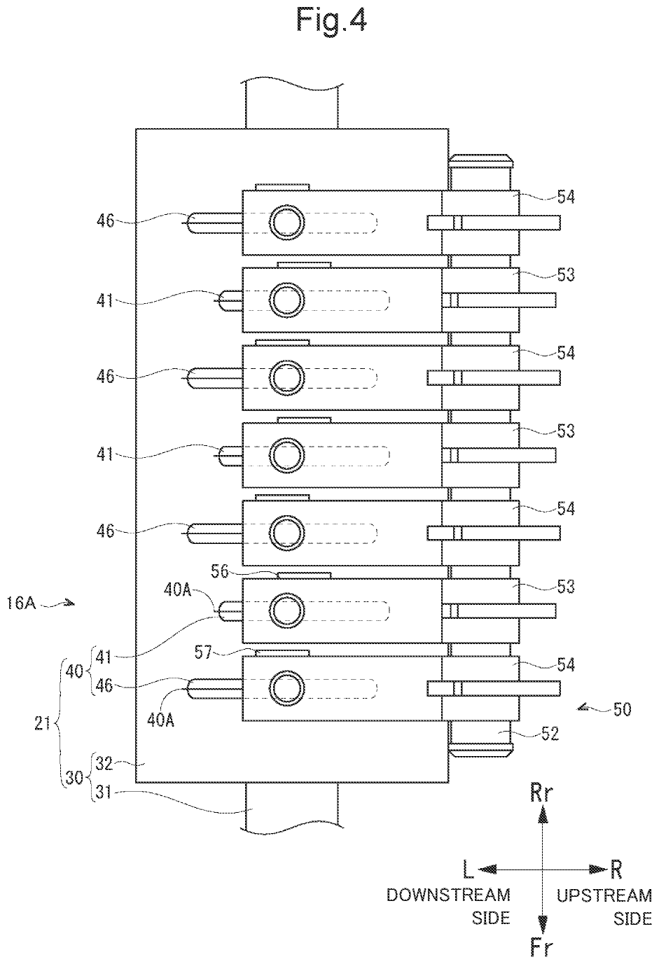

Referring to FIG. 2 to FIG. 4, the medium transport device 16A according to the first embodiment will be described hereunder. FIG. 2 is a side view showing the medium transport device 16A according to the first embodiment. FIG. 3 is a cross-sectional view taken along a line III-III in FIG. 2. FIG. 4 is a plan view showing the medium transport device 16A according to the first embodiment.

As shown in FIG. 2 to FIG. 4, the medium transport device 16A includes the transport roller pair 21 and a support unit 50.

### [Transport Roller Pair 21]

The transport roller pair 21 includes the drive roller 30, and seven follower rollers 40. The drive roller 30 is driven to rotate about the shaft. The follower rollers 40 are each made to rotate about the shaft by the drive roller 30, to transport the sheet P held between the follower rollers 40 and the drive roller 30. The follower rollers 40 each contact the front face of the sheet P delivered from the head unit 12, and on which the image has been formed, and the drive roller 30 contacts the back face of the sheet P.

### [Drive Roller 30]

The drive roller 30 includes a drive shaft 31 extending in the front-back direction (width direction orthogonal to the transport direction), and a roller main body 32 fixed to the circumferential surface of the drive shaft 31. The end portions of the drive shaft 31 are rotatably supported by a frame provided inside the housing 2. The drive shaft 31 is connected to a drive source such as an electric motor, and made to rotate by driving force transmitted from the drive source. The roller main body 32 is a roller made of rubber, having a predetermined width along the axial direction of the drive shaft 31.

### [Follower Roller 40]

The follower rollers 40 are each formed in a disk shape, having a certain thickness. Along the outer circumferential surface of each of the follower rollers 40, a plurality of teeth 40A, protruding in a pin shape, are formed at generally regular intervals. Here, in FIG. 2 and FIG. 4, the plurality of teeth 40A are indicated by a single solid line.

The seven follower rollers 40 includes three first rollers 41 and four second rollers 46 (see FIG. 2 and FIG. 3). The three first rollers 41 and the four second rollers 46 are alternately aligned in the front-back direction (width direction), at generally regular intervals. Since the three first rollers 41 all have the same shape, the following description will focus on one of the first rollers 41. Likewise, since the four second rollers 46 all have the same shape, the following description will focus on one of the second rollers 46.

A first shaft 56 of the first roller 41 has the rotation center shifted to the upstream side in the transport direction, from that of a second shaft 57 of the second roller 46 (see FIG. 3 and FIG. 4). The first roller 41 defines a first nip region N1, in contact with the drive roller 30 (see FIG. 3). The second roller 46 defines a second nip region N2 in contact with the drive roller 30, at a position downstream of the first roller 41 in the transport direction (see FIG. 3). Hereinafter, when a common aspect of the first nip region N1 and the second nip region N2 can be collectively described, these nip regions will be simply referred to as “nip regions N1 and N2”.

The inertia (moment of inertia) of the first roller 41 is set to be smaller than that of the second roller 46. To be more specific, the first roller 41 is smaller (shorter) in diameter, than the second roller 46. Accordingly, the rotation center of the first roller 41 is shifted to the lower side, with respect to that of the second roller 46 (see FIG. 3). The first roller 41 may be given the same weight as the second roller 46, or may be made lighter than the second roller 46, because of being smaller in diameter. The difference in outer diameter between the first roller 41 and the second roller 46 is not specifically limited. The difference in outer diameter may be determined as desired, provided that the first nip region N1 is located upstream of the second nip region N2, and that the impact applied to the sheet P entering into the first nip region N1 can be alleviated.

### [Inertia and Rotation Torque]

The inertia (moment of inertia) I [kg·m\hat{ }2] of a disk of a uniform structure, rotating about a central axis, can be expressed as a following equation 1, and the rotation torque T [N·m] can be expressed as a following equation 2.

$$\\ \begin{matrix}\begin{matrix}I = \frac{1}{δ} {mr}^{2} & \begin{matrix}m : MASS [ kg ] \\ r : RADIUS [ m ]\end{matrix}\end{matrix} & [ Math . 1 ]\end{matrix}$$

$$\\ \begin{matrix}\begin{matrix}T = I \frac{dw}{dt} & \frac{dw}{dt} : ANGULAR ACCELERATION [ rad / {s}^{2} ]\end{matrix} & [ Math . 2 ]\end{matrix}$$

It can be approximated that the first roller 41 and the second roller 46 are disks of a uniform structure. Therefore, as is apparent from the equation 1, the first roller 41 becomes smaller in inertia than the second roller 46, by being made smaller in diameter than the second roller 46. Further, as is apparent from the equation 2, since a rotation torque T becomes smaller because of the inertia I being smaller, the force (torque) required for rotating the first roller 41 becomes smaller than the force required for rotating the second roller 46. In other words, the first roller 41 becomes easier to rotate about the shaft, than the second roller 46.

### [Support Unit 50]

As shown in FIG. 2 to FIG. 4, the support unit 50 includes a roller holder 51, a pivotal shaft 52, three first pivotal arms 53, four second pivotal arms 54, and seven biasing members 55. Since the three first pivotal arms 53 all have the same shape, the following description will focus on one of the first pivotal arms 53. Likewise, since the four second pivotal arms 54 all have the same shape, and so do the seven biasing members 55, the following description will focus on one of the second pivotal arms 54 and one of the biasing members 55.

Hereinafter, when a common aspect of the first pivotal arm 53 and the second pivotal arm 54 can be collectively described, these pivotal arms will be simply referred to as “pivotal arms 53 and 54”. In addition, the roller holder 51 is not shown in FIG. 4.

### [Roller Holder 51 and Pivotal Shaft 52]

The roller holder 51 is formed in a box shape with the lower side and the left side opened, and accommodates therein the seven follower rollers 40 (see FIG. 2 and FIG. 3). The pivotal shaft 52 extends in the front-back direction (width direction), and is rotatably supported by the front and back side walls of the roller holder 51 (see FIG. 2).

### [First Pivotal Arm 53 and Second Pivotal Arm 54]

The three first pivotal arms 53 and the four second pivotal arms 54 are alternately aligned in the front-back direction (width direction), at generally regular intervals (see FIG. 2 and FIG. 4). The respective right-side end portions of the pivotal arms 53 and 54 are fixed to the pivotal shaft 52. The pivotal arms 53 and 54 are supported by the pivotal shaft 52, so as to pivot in the up-down direction. The first pivotal arm 53 extends to the left (one side in the transport direction) from the pivotal shaft 52. At the distal end portion of the extended first pivotal arm 53, the first roller 41 is rotatably supported by the first shaft 56. The second pivotal arm 54 extends to the left from the pivotal shaft 52. At the distal end portion of the extended second pivotal arm 54, the second roller 46 is rotatably supported by the second shaft 57.

### [Biasing Member 55]

The biasing member 55 is, for example, a compression spring. The biasing member 55 is provided between the top plate of the roller holder 51 and one of the pivotal arms 53 and 54 (see FIG. 2 and FIG. 3). The biasing member serves to bias the pivotal arms 53 and 54 toward the drive roller 30. The pivotal arms 53 and 54 are made to pivot downward, so that the first roller 41 and the second roller 46 of the follower rollers 40 are pressed against the surface of the drive roller 30, with a predetermined pressure. The seven biasing members 55 all have the same spring constant. Accordingly, the seven follower rollers 40 are pressed against the surface of the drive roller 30, with generally the same pressure.

The first nip region N1 and the second nip region N2 are shifted from each other in the circumferential direction (transport direction), with respect to the curved outer circumferential surface of the roller main body 32 of the drive roller 30. Therefore, it can be approximated that the first nip region N1 and the second nip region N2 are located at generally the same height, though not strictly at the same height (see FIG. 3). Since the first roller 41 is smaller in diameter than the second roller 46, the first pivotal arm 53 pivots to the lower side with respect to the second pivotal arm 54, and therefore the first shaft 56, which is the rotation center of the first roller 41, is located at an obliquely lower position on the upstream side, with respect to the second shaft 57, which is the rotation center of the second roller 46 (see FIG. 3).

### [Working of Medium Transport Device 16A]

Hereunder, the working of the medium transport device 16A, in other words how the transport roller pair 21 transports the sheet P, will be described.

The leading edge of the sheet P that has passed the head unit 12 reaches the first nip region N1, which is the contact position between the drive roller 30 and the three first rollers 41. As already described, the first roller 41 is smaller in diameter, and therefore smaller in inertia, than the second roller 46. Accordingly, the first roller 41 smoothly rotates, without causing a remarkable change in transport speed of the sheet P. Therefore, the sheet P is exempted from transmission of a large impact or vibration. As the sheet P proceeds further, the first pivotal arm 53 is elevated by an amount corresponding to the thickness of the sheet P, against the biasing force of the biasing member 55, and the sheet P is caught in the first nip region N1. The drive roller 30 exerts a transport force to the sheet P, and the first roller 41 also rotates, so as to follow up the rotation of the drive roller 30, via the sheet P.

Thereafter, the leading edge of the sheet P reaches the second nip region N2, which is the contact position between the drive roller 30 and the four second rollers 46. At this point, since the sheet P is already caught in the first nip region N1, the transport speed of the sheet P barely changes. Accordingly, the sheet P is exempted from suffering a large impact, and vibration is not, or barely, transmitted to the sheet P. As the sheet P proceeds still further, the second pivotal arm 54 is elevated by an amount corresponding to the thickness of the sheet P, against the biasing force of the biasing member 55, and the sheet P is caught in the second nip region N2. The second roller 46 rotates, so as to follow up the rotation of the drive roller 30, via the sheet P.

The sheet P is transported, being held between the two nip regions N1 and N2, and delivered to the decurling device 17 located on the downstream side.

Here, the aforementioned known technique can alleviate, to a certain extent, the impact applied to the medium entering into the nip region. However, with the recent increase in image forming speed, the medium transport speed is also increased, and therefore the foregoing technique may fail to sufficiently reduce the impact, and the image forming operation may be affected.

Regarding the transport roller pair 21 according to the first embodiment, in contrast, since the first roller 41 is smaller in diameter than the second roller 46, the inertia of the first roller 41 becomes smaller than that of the second roller 46. In other words, the first roller 41 can be made to rotate with a smaller force, than the force required to rotate the second roller 46. Accordingly, when the leading edge of the sheet P collides with the first roller 41, the first roller 41 easily rotates so as to absorb the impact (force exerted in the transport direction), and therefore the impact, applied to the sheet P entering into the first nip region N1, can be reduced. As result, the impact transmitted from the leading edge of the sheet P to the rear portion thereof can be alleviated, and therefore occurrence of color shift, in the image being formed on the rear portion of the sheet P, can be prevented.

In addition, in the transport roller pair 21 according to the first embodiment, the number of the first rollers 41 is fewer than the number of the second rollers 46. Such a configuration further assures that the impact applied to the sheet P entering into the first nip region N1 is reduced.

Further, in the medium transport device 16A according to the first embodiment, the plurality of pivotal arms 53 and 54 individually pivotably support the respective first rollers 41 and the second rollers 46, constituting the plurality of follower rollers 40. Therefore, the first rollers 41 and the second rollers 46, different in outer diameter from each other, can be made to contact the surface of the drive roller 30, with generally constant pressure.

### Other Embodiments

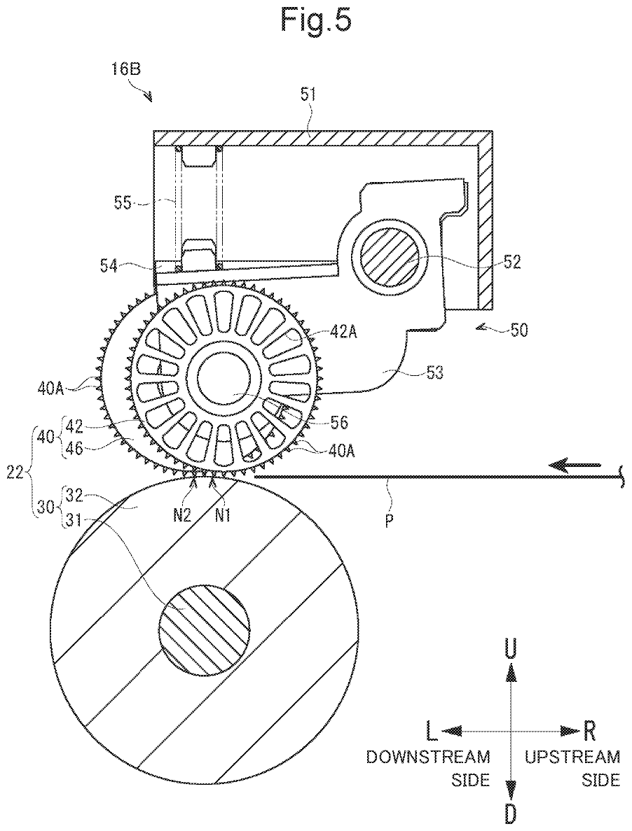

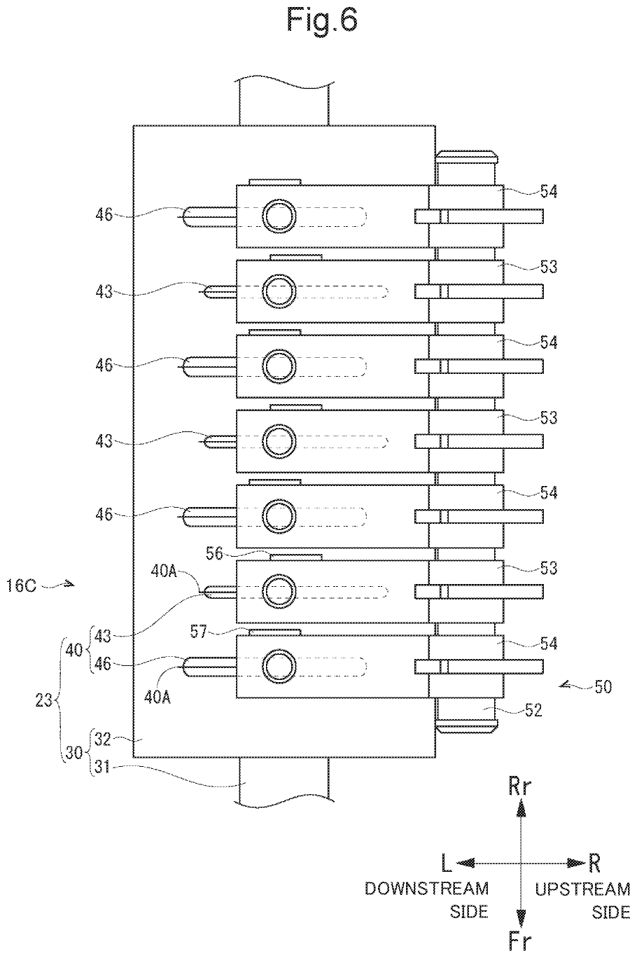

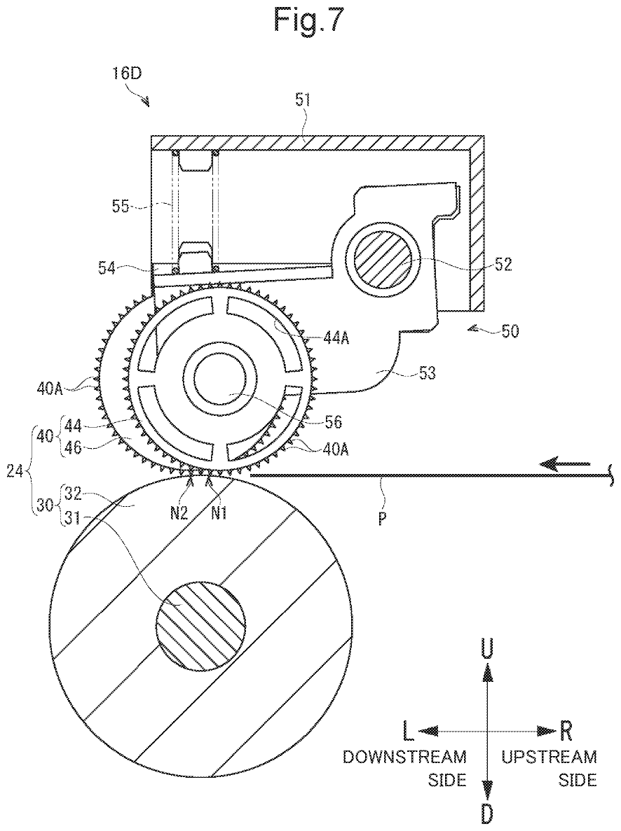

Referring now to FIG. 5 to FIG. 7, other embodiments of the disclosure will be described hereunder. FIG. 5 is a cross-sectional view showing a medium transport device 16B according to a second embodiment. FIG. 6 is a plan view showing a medium transport device 16C according to a third embodiment. FIG. 7 is a cross-sectional view showing a medium transport device 16D according to a fourth embodiment. The elements same as or corresponding to those of the transport roller pair 21 according to the first embodiment are given the same numeral, and the description of such elements will not be repeated.

### Second Embodiment

In a transport roller pair 22 according to the second embodiment, a first roller 42 is lighter in weight than the second roller 46. Accordingly, the inertia of the first roller 43 is smaller than that of the second roller 46. To reduce the weight of the first roller 42, for example, slits 42A may be formed in the first roller 42 as shown in FIG. 5, within an extent that the necessary rigidity can be secured. Alternatively, a material lighter in weight than that of the second roller 46 may be employed for the first roller 42. Although it is preferable that the weight of the first roller 42 is approximately half a weight of the second roller 46, the disclosure is not limited to such a structure. The weight of the first roller 42 may be modified as desired, provided that the impact applied to the sheet P entering into the first nip region N1 can be alleviated. In this embodiment, the first roller 42 has generally the same outer diameter, as that of the second roller 46.

With the transport roller pair 22 according to the second embodiment, since the first roller 42 is lighter in weight than the second roller 46, the inertia of the first roller 42 is smaller than that of the second roller 46 (see equation 1 above). Therefore, the same advantageous effects as those provided by the transport roller pair 21 according to the first embodiment, such as the reduction in impact applied to the sheet P entering into the first nip region N1, can be attained.

### Third Embodiment

As shown in FIG. 6, in a transport roller pair 23 according to the third embodiment, a first roller 43 is thinner than the second roller 46. Accordingly, the inertia of the first roller 43 becomes smaller than that of the second roller 46. Although it is preferable that the thickness of the first roller 43 is approximately half a thickness of the second roller 46, the disclosure is not limited to such a structure. The thickness of the first roller 43 may be modified as desired, provided that the impact applied to the sheet P entering into the first nip region N1 can be alleviated. In this embodiment, the first roller 43 has generally the same outer diameter as that of the second roller 46, and therefore the first roller 43 may be made lighter in weight than the second roller 46.

With the transport roller pair 23 according to the third embodiment, since the first roller 43 is lighter in thinner than the second roller 46, the inertia of the first roller 43 is smaller than that of the second roller 46. Therefore, the same advantageous effects as those provided by the transport roller pair 21 according to the first embodiment, such as the reduction in impact applied to the sheet P entering into the first nip region N1, can be attained.

### Fourth Embodiment

In a transport roller pair 24 according to the fourth embodiment, the weight of a first roller 44 is the same as, or lighter than, that of the second roller 46. In addition, the first roller 44 is formed in such a weight distribution that the radially outer portion thereof is lighter than that of the second roller 46. Accordingly, the inertia of the first roller 44 becomes smaller than that of the second roller 46. To reduce the weight of the radially outer portion of the first roller 44, for example, slits 44A may be formed only in the radially outer portion of the first roller 44 as shown in FIG. 7, within an extent that the necessary rigidity can be secured. Alternatively, a material lighter in weight, than the material of the radially inner portion of the first roller 44, may be employed for the radially outer portion of the first roller 44. In this embodiment, the first roller 44 has generally the same outer diameter, as that of the second roller 46.

With the transport roller pair 24 according to the fourth embodiment, the first roller 44 is formed in such a weight distribution that the radially outer portion thereof is lighter, which makes the inertia of the first roller 44 smaller than that of the second roller 46. Therefore, the same advantageous effects as those provided by the transport roller pair 21 according to the first embodiment, such as the reduction in impact applied to the sheet P entering into the first nip region N1, can be attained.

Here, although the first rollers 42 to 44, of the transport roller pairs 22 to 24 according to the second to fourth embodiments, are formed in generally the same outer diameter as the second roller 46, (see FIG. 5 to FIG. 7), the disclosure is not limited to such a configuration. The first rollers 42 to 44 may be made smaller in diameter than the second roller 46, like the first roller 41 of the transport roller pair 21 according to the first embodiment. Further, provided that the impact applied to the sheet P entering into the first nip region N1 can be reduced, the first rollers 42 to 44 may be formed in a larger diameter than that of the second roller 46.

Although seven follower rollers 40 (three first rollers 41 to 44, and four second rollers 46) are provided in the transport roller pairs 21 to 24 according to the first to fourth embodiments, the disclosure is not limited to such a configuration. It suffices that two or more follower rollers 40 are provided, and to be more specific, it suffices that at least one first roller 41 to 44 and at least one second roller 46 are provided. Alternatively, a plurality of sets of the follower rollers, each set including seven follower rollers 40 (pivotal arms 53 and 54) may be provided for one drive roller 30, such that the plurality of sets are aligned in the axial direction with an interval between each other, and supported in common by one pivotal shaft 52.

In addition, although the three first rollers 41 to 44 and the four second rollers 46 are alternately aligned at regular intervals, in the transport roller pairs 21 to 24 according to the first to fourth embodiments, the disclosure is not limited to such a configuration. The order in which the three first rollers 41 to 44 and the four second rollers 46 are aligned in the width direction, and the interval defined between each other, may be modified as desired. For example, three first rollers 41 to 44 may be located between two pairs of the second rollers 46. As another example, the three first rollers 41 to 44 and the four second rollers 46 may be aligned at irregular intervals.

Further, although the seven biasing members 55 all have the same spring constant, in the transport roller pair 21 to 24 according to the first to fourth embodiments, the disclosure is not limited to such a configuration. For example, the biasing member 55 that biases the second pivotal arm 54 (second spring) may be given a larger spring constant, than that of the biasing member 55 that biases the first pivotal arm 53 (first spring). Thus, the second roller 46 may be pressed against the drive roller 30 with a larger pressure (load) than the first rollers 41 to 44.

Further, although the recording heads 14 eject the ink droplets from the nozzles, in the foregoing image forming apparatus 1, the disclosure is not limited to such a configuration. The liquid droplets to be ejected from the nozzles are not limited to the ink droplets, but may be, for example, water, a liquid adhesive, or a liquid synthetic resin.

Still further, the image forming apparatus 1 is configured as a color printer in the foregoing embodiments, the disclosure is not limited thereto. The image forming apparatus 1 may be a monochrome printer, a copier, or a facsimile machine. Further, although the image forming apparatus 1 is configured as an ink jet printer in the embodiments, the disclosure is not limited thereto. The image forming apparatus 1 may be configured to execute an electrophotographic printing.

The aforementioned description represents some embodiments of the transport roller pair, the medium transport device, and the image forming apparatus according to the disclosure, and the technical scope of the disclosure is not limited to such embodiments. The disclosure may be modified, substituted, or altered without departing from the scope of the technical idea, and the appended claims encompass all the aspects that may be included in the scope of the technical idea.

While the present disclosure has been described in detail with reference to the embodiments thereof, it would be apparent to those skilled in the art the various changes and modifications may be made therein within the scope defined by the appended claims.

What is claimed is:

1. A transport roller pair comprising:
a drive roller to be driven to rotate about a shaft; and
a follower roller set that transports a medium held between the drive roller and the follower roller set, by being made to rotate about a shaft by the drive roller,
wherein the follower roller set includes:
at least one first roller that forms a first nip region by contacting the drive roller; and
at least one second roller that forms a second nip region by contacting the drive roller, at a position downstream of the first roller in a transport direction of the medium, and
the first roller is smaller in inertia than the second roller.

2. The transport roller pair according to claim 1,
wherein the first roller is smaller in diameter than the second roller.

3. The transport roller pair according to claim 1,
wherein the first roller is lighter in weight than the second roller.

4. The transport roller pair according to claim 1,
wherein the first roller is thinner than the second roller.

5. The transport roller pair according to claim 1,
wherein the first roller has a same weight as, or is lighter in weight than, the second roller, and
the first roller is formed in such a weight distribution that a radially outer portion is lighter in weight than a radially outer portion of the second roller.

6. The transport roller pair according to claim 1,
wherein a plurality of the first rollers and a plurality of the second rollers are aligned in a width direction orthogonal to the transport direction, with an interval between each other, and
a number of the first rollers is fewer than a number of the second rollers.

7. A medium transport device comprising:
the transport roller pair according to claim 6;
a pivotal shaft extending in a width direction;
a plurality of first pivotal arms each pivotably supported by the pivotal shaft, and configured to rotatably support the first roller, on a side of a distal end extending from the pivotal shaft to one side in the transport direction;
a plurality of second pivotal arms each pivotably supported by the pivotal shaft, and configured to rotatably support the second roller, on a side of a distal end extending from the pivotal shaft to one side in the transport direction; and
a plurality of biasing members that respectively bias the first pivotal arms and the second pivotal arms, toward the drive roller.

8. The medium transport device according to claim 7,
wherein the biasing member includes a first spring that biases the first pivotal arm, and a second spring that biases the second pivotal arm, and
the second spring is larger in spring constant than the first spring.

9. An image forming apparatus comprising:
the transport roller pair according to claim 1; and
an image forming device that forms an image on the medium.
